(19) United States
(12) Patent Application Publication
(10) Pub. No.: US 2023/0161421 A1
(43) Pub. Date: May 25, 2023

(54) CURSOR MARKING METHOD, SWITCHING DEVICE AND COMPUTER SYSTEM

(71) Applicant: ATEN INTERNATIONAL CO., LTD., New Taipei City (TW)

(72) Inventor: Kuo-Feng KAO, New Taipei City (TW)

(21) Appl. No.: 18/050,049

(22) Filed: Oct. 27, 2022

(30) Foreign Application Priority Data
Nov. 24, 2021 (TW) 110143821

(51) Int. Cl. G06F 3/023; G06F 3/14; G06F 3/0354; G06F 3/038

(52) U.S. Cl. CPC G06F 3/023; G06F 3/1423; G06F 3/03543; G06F 3/038

(57) ABSTRACT

The present disclosure provides a cursor marking method, a switching device, and a computer system. The cursor marking method includes: by a switching device, detecting an operation of at least one input device to at least one computer device via the switching device, wherein the at least one input device is configured to perform at least one trigger operation, to trigger at least one operating system of the at least one computer device to execute a cursor position marking function; and when the switching device detects the at least one trigger operation, by the switching device, driving the at least one operating system of the at least one computer device to execute the cursor position marking function, to display cursor position marking effect on at least one display device electrically coupled to the at least one computer device.

### CROSS-REFERENCE TO RELATED APPLICATION

This application claims priority to Taiwan Application Serial Number 110143821, filed Nov. 24, 2021, which is herein incorporated by reference in its entirety.

### BACKGROUND

### Field of Invention

This disclosure relates to an operating method of a computer system, and in particular to a cursor marking method of the computer system which includes a switching device.

### Description of Related Art

KM (Keyboard and Mouse) switcher is an electronic device which allows the user to operate multiple computers through one group of keyboard and mouse. Generally speaking, the user can switch from operating a computer to operating another computer by the KM switcher. Each of the computers is usually connected to one monitor, and a cursor is only displayed on the monitor connected to the computer which is currently operated by the user.

In the structure of the aforementioned system, when the number of the monitors is over and/or multiple monitors display too much information simultaneously, the user often cannot find the display position of the cursor and thereby affecting operation. For solving the problem of being unable to find the cursor, the prior art helps the user to find the display positon of the cursor by external software or hardware, but also leads to increased cost and the incompatible software.

### SUMMARY

An aspect of present disclosure relates to a cursor marking method. The cursor marking method includes: by a switching device, detecting an operation of at least one input device to at least one computer device via the switching device, wherein the at least one input device is configured to perform at least one trigger operation, to trigger at least one operating system of the at least one computer device to execute a cursor position marking function; and when the switching device detects the at least one trigger operation, by the switching device, driving the at least one operating system of the at least one computer device to execute the cursor position marking function, to display cursor position marking effect on at least one display device electrically coupled to the at least one computer device.

Another aspect of present disclosure relates to a switching device. The switching device includes at least one input interface, a plurality of output interfaces and a processor. The at least one input interface is configured to electrically couple to at least one input device. The plurality of output interfaces is configured to electrically couple to a plurality of computer devices. The processor is electrically coupled to the at least one input interface and the plurality of output interfaces, is configured to receive at least one input signal generated by the at least one input device via the at least one input interface, and is configured to output the at least one input signal via one of the plurality of output interfaces to operate one of the plurality of computer devices. The processor is further configured to generate at least one driving signal in response to at least one trigger signal that the at least one input device generates through a trigger operation, to drive a corresponding operating system of one of the plurality of computer devices to execute a cursor position marking function via a corresponding output interface of the plurality of output interfaces.

Another aspect of present disclosure relates to a computer system. The computer system includes a plurality of display devices, a plurality of computer devices, at least one input device and a switching device. The plurality of computer devices is electrically coupled to the plurality of display devices respectively. The at least one input device is configured to perform at least one trigger operation to generate at least one trigger signal. The switching device is electrically coupled between the at least one input device and the plurality of computer devices and is configured to drive a corresponding operating system of one of the plurality of computer devices to execute a cursor position marking function in response to the at least one trigger signal generated by the at least one input device, to display cursor position marking effect on a corresponding display device electrically coupled to one of the plurality of computer devices.

In sum, the computer system of the present disclosure processes the input signal generated by the input device through the switching device to analyze whether the user desires to know the display position of the cursor on the display devices. When determining that the user desires to know the display position of the cursor, the switching device simulates the driving signal capable of driving the operating system to execute the original cursor position marking function according to the operating system of the computer device currently operated by the input device, to inform the user the display position of the cursor by the cursor position marking effect. In such way, the computer system of the present disclosure can inform the user the display position of the cursor without the external software or hardware, so as to reduce cost and to avoid incompatible problem.

### BRIEF DESCRIPTION OF THE DRAWINGS

FIG. 1 is a schematic diagram of a computer system in accordance with some embodiments of the present disclosure;

FIG. 2 is a block diagram of a computer system in accordance with some embodiments of the present disclosure;

FIG. 3A is a flow diagram of a cursor marking method in accordance with some embodiments of the present disclosure;

FIG. 3B is a flow diagram of a cursor marking method in accordance with other embodiments of the present disclosure;

FIGS. 4A-4C are schematic diagrams of displaying a cursor position marking effect in accordance with some embodiments of the present disclosure; and

FIG. 5 is a flow diagram of an operating method of a switching device in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

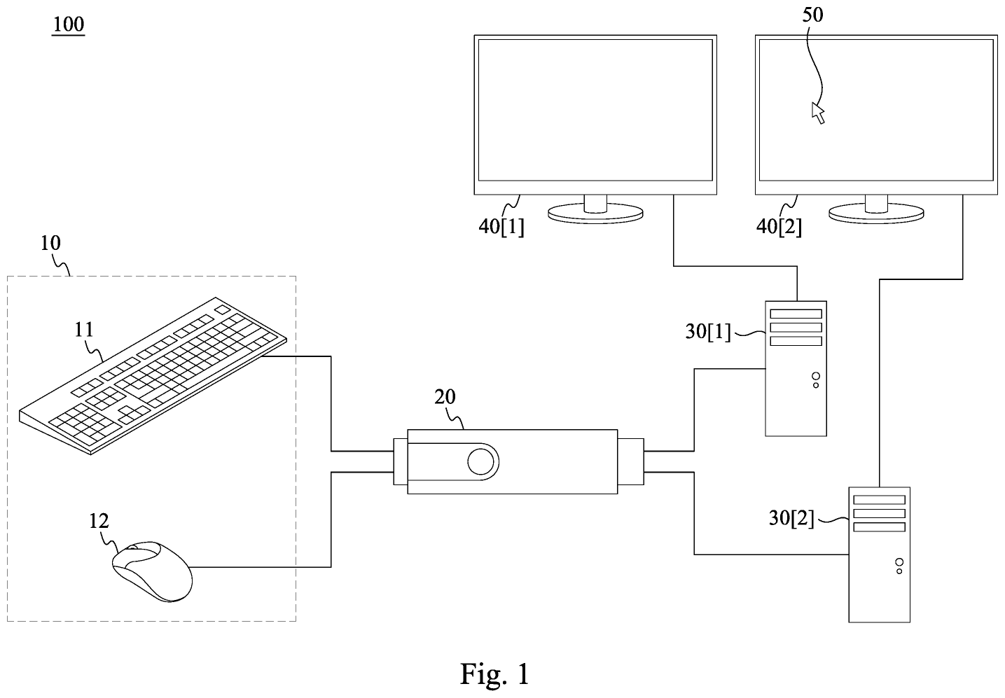

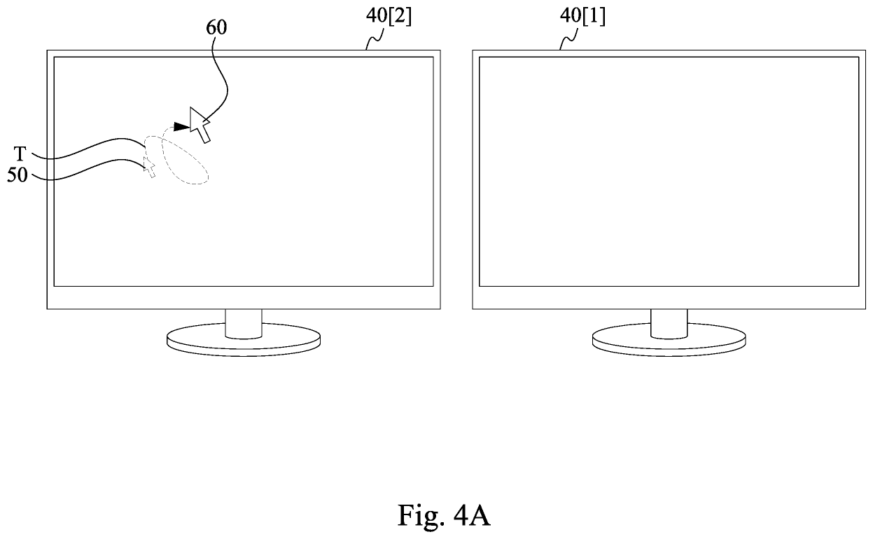

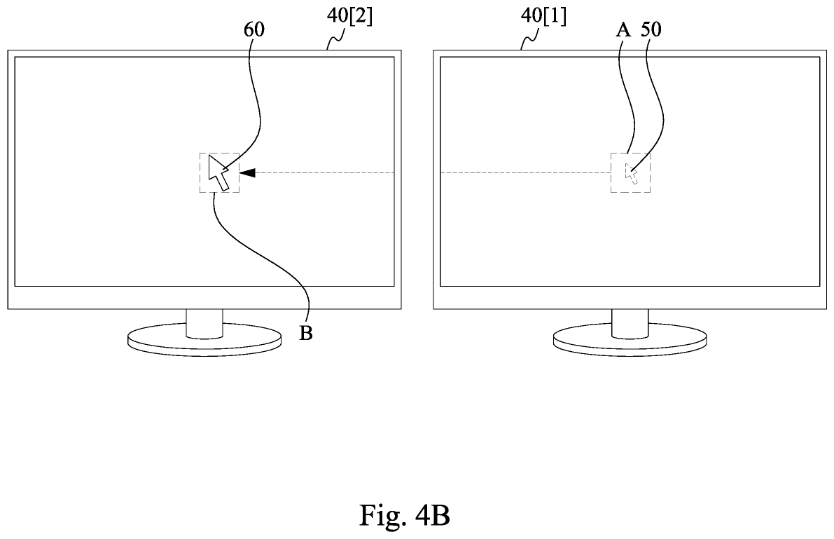

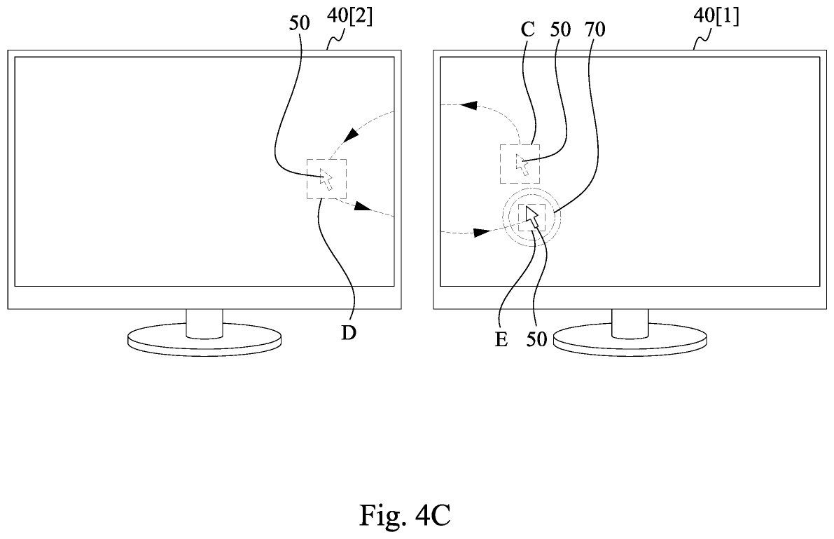

Referring to FIG. 1, FIG. 1 is a schematic diagram of a computer system 100 in accordance with some embodiments of the present disclosure. In some embodiments, the computer system 100 includes at least one input device 10, a switching device 20, a plurality of computer devices 30[1]-30[2] and a plurality of display devices 40[1]-40[2]. As shown in FIG. 1, the switching device 20 is electrically coupled between the input device 10 and the computer devices 30[1]-30[2], and the computer devices 30[1]-30[2] are electrically coupled to the display devices 40[1]-40[2] respectively. The display devices 40[1]-40[2] are capable of displaying a cursor 50 corresponding to the operation of the input device 10. In some embodiments, the input device 10 includes a keyboard 11 and a mouse 23, and is electrically coupled to the switching device 20. During the operation, the user of the computer system 100 can perform at least one trigger operation through the input device 10, so that the switching device 20 is triggered to drive one of the computer devices 30[1]-30[2] to display a cursor position marking effect of (e.g., 60 of FIGS. 4A-4B, 70 of FIG. 4C) the cursor 50 on one of the display devices 40[1]-40[2].

In some embodiments, the terms “cursor position marking effect” as used herein represents any effect capable of enabling the user of the computer system 100 to notice the position of the cursor 50, where would be described in detail later. When one of the display devices 40[1]-40[2] displays the cursor position marking effect, the user of the computer system 100 would thereby be aware of the display position of the cursor 50 (as shown in FIG. 1) on the display devices 40[1]-40[2].

It can be appreciated that the amount of the computer devices 30[1]-30[2] and the display devices 40[1]-40[2] can be any number greater than or equal to 2 and be not limited to those of FIG. 1 (i.e., 2).

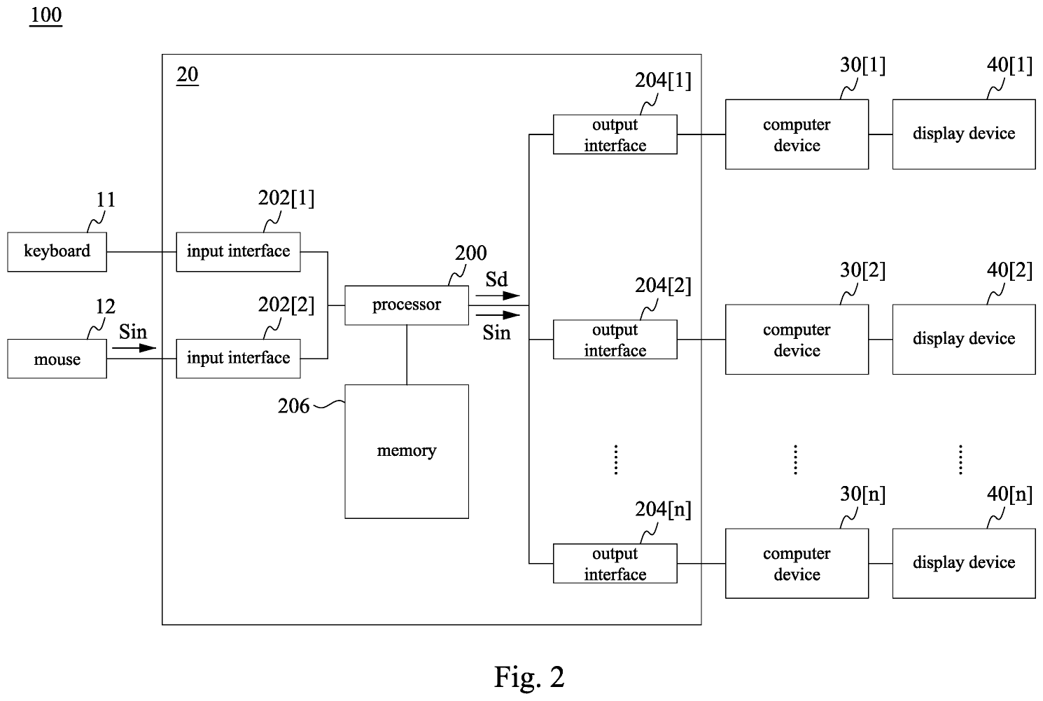

Referring to FIG. 2, FIG. 2 is a schematic diagram of a specific structure corresponding to the computer system 100 of FIG. 1 in accordance with some embodiments of the present disclosure. In the embodiment of FIG. 2, the computer system 100 includes n of the computer devices 30[1]-30[n] and n of the display devices 40[1]-40[n], in which n is greater than or equal to 2.

As shown in FIG. 2, in some embodiments, the switching device 20 includes a processor 200, a plurality of input interfaces 202[1]-202[2], a plurality of output interfaces 204[1]-204[n] and a memory 206. The processor 200 is electrically coupled to the input interfaces 202[1]-202[2], the output interfaces 204[1]-204[n] and the memory 206. The input interfaces 202[1]-202[2] are configured to be electrically coupled to the keyboard 11 and the mouse 12 respectively. The output interfaces 204[1]-204[n] are configured to be coupled to the computer devices 30[1]-30[n] respectively. During general operation, the user can operate the keyboard 11 and the mouse 12 and can control one of the computer devices 30[1]-30[n] through the switching device 20. In some embodiments, the keyboard 11 and the mouse 12 are configured to allow the user to operate and/or input information, to generate at least one input signal correspondingly. The processor 200 is configured to receive the input signal generated by the keyboard 11 and the mouse 12 through the input interfaces 202[1]-202[2] and is configured to output the input signal generated by the keyboard 11 and the mouse 12 as corresponding output signal through one of the output interfaces 204[1]-204[n], so as to operate one of the computer devices 30[1]-30[n]. For example, the user operates the mouse 12 to generate an input signal Sin. The processor 220 receives the input signal Sin through the input interface 202[2] and outputs the input signal Sin to the computer device 30[2] through the output interface 204[2], so as to control the cursor 50 (as shown in FIG. 1) displayed by the display device 40[2].

In some embodiments, the computer devices 30[1]-30[n] each store an operating system for executing their own computer operating programs. For example, the computer device 30[1] has a first operating system, and the computer device 30[2] has a second operating system. It can be appreciated that the computer device 30[n] also has a corresponding operating system. In some embodiments, the first operating system is same as the second operating system. For example, the first operating system and the second operating system are both Windows, Mac, Linux or other operating systems. In some embodiments, the first operating system is different from the second operating system. For example, the first operating system is Windows, and the second operating system is Mac, Linux or other operating systems. In other words, the operating systems of the computer devices 30[1]-30[n] can be all same or all different, or can be part same, part different.

The operating systems of the computer devices 30[1]-30[n] each further has a cursor position marking function. For example, the first operating system of the computer device 30[1] provides a first cursor position marking function, and the second operating system of the computer device 30[2] provides a second cursor position marking function. The terms “cursor position marking function” as used herein is an original function of the operating system for informing the user the position of the cursor. Descriptions would be made by taking Windows operating system as an example, if the user clicks or presses “Ctrl” key on the keyboard, the computer device would control the display device to display a dynamic image (e.g., a ripple shrinking from a predetermined radius and finally disappearing) at the position of the cursor, to inform the user the position of the cursor. Descriptions would be made by taking Mac operating system as an example, if the user rapidly moves the mouse back and forth, the computer device would control the display device to display an enlarged cursor, to inform the user the position of the cursor.

In some embodiments, as the embodiment of FIG. 1, the input device 10 performs at least one trigger operation in response to the user operation to generate at least one trigger signal (not shown), thereby triggering the switching device 20 driving one of the computer devices 30[1]-30[2] to display the cursor position marking effect of the cursor 50 on one of the display devices 40[1]-40[2]. In particular, as the embodiment of FIG. 2, the trigger signal generated by the mouse 12 is the input signal Sin related to a first predetermined movement operation of the mouse 12 (i.e., at least one trigger operation). For example, the trigger signal generated by the mouse 12 is the input signal Sin generated when the mouse 12 is rapidly moved in a small area (i.e., the first predetermined movement operation). For another example, the trigger signal generated by the mouse 12 is the input signal Sin generated when the mouse 12 is moved to switch from operating one computer device to operating another computer device (i.e., the first predetermined movement operation). The implementations of the aforementioned first predetermined movement operation are not limited thereto, and can be practically set according to the operating habit of the user. In response to the trigger signal generated by the mouse 12, the processor 200 generates at least one driving signal Sd and outputs the driving signal Sd through one of the output interfaces 204[1]-204[n], to drive the corresponding operating system of one of the computer devices 30[1]-30[n] to execute the cursor position marking function.

In some embodiments, the driving signal Sd is related to an operation of at least one predetermined key of the keyboard 11 being pressed, a second predetermined movement operation of the mouse 12, or a combination thereof. For example, the first operating system of the computer device 30[1] currently operated by the mouse 12 is Windows operating system. Accordingly, the processor 200 generates the driving signal Sd (i.e., the first driving signal) related to the operation of “Ctrl” key of the keyboard 11 being pressed and outputs the driving signal Sd to the computer device 30[1] through the output interface 204[1], so that the first operating system of the computer device 30[1] executes the first cursor position marking function. For another example, the second operating system of the computer device 30[2] currently operated by the mouse 12 is Mac operating system. Accordingly, the processor 200 generates the driving signal Sd (i.e., the second driving signal) related to the rapid back-and-forth movement of the mouse 12 (i.e., the second predetermined movement operation) and outputs the driving signal Sd to the computer device 30[2] through the output interface 204[2], so that the second operating system of the computer device 30[2] executes the second cursor position marking function. In other words, the processor 200 of the switching device 20 would correspondingly generate different driving signal Sd according to different operating system, thereby driving different operating system to execute original cursor position marking function. In addition, the cursor position marking effects displayed by the display devices may also be different due to different operating systems. Therefore, when the computer devices with different operating systems are operated by the user, the driving signal can be generated to execute the cursor position marking function as long as the specific predetermined movement operation is performed, so as to help the user find the position of the cursor rapidly. That is to say, the user is not required to remember corresponding operating system of the computer device being operated currently and corresponding cursor marking activation manner thereof to activate the cursor position marking function.

Furthermore, the driving signal Sd is the signal that the processor 200 of the switching device 20 generates by simulating the operation of the keyboard 11 and/or the mouse 12 according to the operating system of the computer device. Accordingly, when the computer device receives the driving signal Sd, the processor (not shown) of the computer device would consider that the user performs related operation on the keyboard 11 and/or the mouse 12, so as to execute the cursor position marking function. However, the user does not really perform the related operation (e.g., pressing “Ctrl” key on the keyboard 11, rapidly moving the mouse 12 back and forth) on the keyboard 11 and/or the mouse 12.

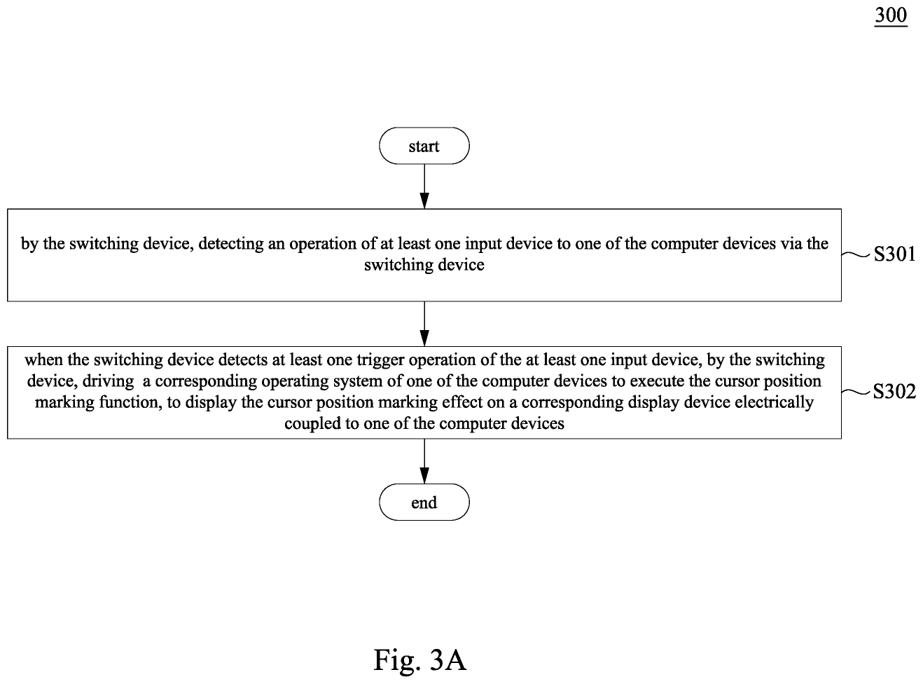

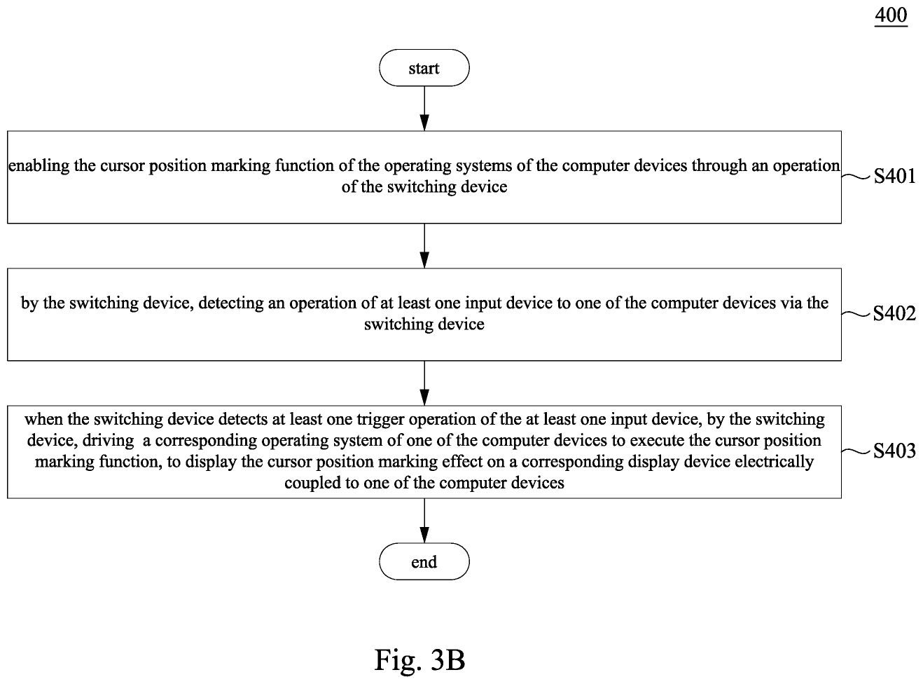

Referring to FIG. 3A, FIG. 3A is a flow diagram of a cursor marking method 300 in accordance with some embodiments of the present disclosure. The cursor marking method 300 can be executed by the computer system 100 of FIG. 1 or 2, but the present disclosure is not limited herein. The cursor marking method 300 includes steps S301-S302. For convenience of description, the cursor marking method 300 would be described below with reference to FIGS. 1-2. In the embodiment of FIG. 3A, the cursor position marking functions of the operating systems of the computer devices 30[1]-30[n] have been enabled, so that step S301 is executed. In step S301, the switching device 20 detects an operation of at least one input device (i.e., the keyboard 11 and/or the mouse 12) on one of the computer devices 30[1]-30[n] via the switching device 20.

In step S302, when the switching device 20 detects the at least one trigger operation of the at least one input device (e.g., the aforementioned first predetermined movement operation of the mouse 12), the switching device 20 drives a corresponding operating system of one of the computer devices 30[1]-30[n] to execute the cursor position marking function to display the cursor position marking effect on a corresponding display device electrically coupled to the one of the computer devices 30[1]-30[n]. For example, the switching device 20 can determine whether the input signal Sin generated by the mouse 12 is related to the aforementioned first predetermined movement operation by analyzing the input signal Sin generated by the mouse 12. If the determination result of the switching device 20 is “yes”, it represents that the trigger operation is detected. If the determination result of the switching device 20 is “no”, it represents that the trigger operation is not detected. The operation that the switching device 20 drives one of the computer devices 30[1]-30[n] is same or similar to those of the above embodiments, and therefore the description thereof is omitted herein.

Referring to FIG. 3B, FIG. 3B is a flow diagram of a cursor marking method 400 in accordance with some embodiments of the present disclosure. The cursor marking method 400 can be executed by the computer system 100 of FIG. 1 or 2, but the present disclosure is not limited herein. The cursor marking method 400 includes steps S401-S403. For convenience of description, the cursor marking method 400 would be described below with reference to FIGS. 1-2. In the embodiment of FIG. 3B, the cursor position marking functions of the operating systems of part or all of the computer devices 30[1]-30[n] have not been enabled yet, so that step S401 is executed. In step S401, the cursor position marking functions of the operating systems of the computer devices 30[1]-30[n] are enabled through the operation of the switching device 20.

In some embodiments corresponding to step S401, the user manually operates the keyboard 11 and/or the mouse 12 to sequentially enable the cursor position marking functions of the operating systems of the computer devices 30[1]-30[n]. Descriptions would be made by taking the computer device 30[1] as an example, the switching device 20 transmits a first enable signal (not shown), which is generated by the keyboard 11 and/or the mouse 12 in response to the user operation, to the computer device 30[1], so as to enable the first cursor position marking function of the first operating system of the computer device 30[1]. In a practical application, the first enable signal transmitted by the switching device 20 is a series of input signal Sin generated by the mouse 12, and the series of input signal Sin is generated in response to an operation that the user control the mouse 12 to open a “Pointer Options” window of Windows operating system and to check a box of “Show location of pointer when I press the CTRL key”. The arrangements of other computer devices 30[2]-30[n] can be deduced by analogy, and therefore the descriptions thereof are omitted herein. It can be appreciated that the first enable signal transmitted by the switching device 20 may be different for different operating system.

In some embodiments corresponding to step S401, the user controls the switching device 20 to enter a first setting mode through an external device (e.g., a mobile device of the user) or by pressing a button (not shown) arranged on the switching device 20, so that the switching device 20 automatically enables the cursor position marking functions of the operating systems of the computer devices 30[1]-30[n]. In the first setting mode, the switching device 20 would not transmit the input signal Sin generated by the keyboard 11 and/or the mouse 12 to the computer devices 30[1]-30[n]. When entering the first setting mode, the switching device 20 automatically executes a setting program (not shown) stored in the memory 206 to enable the cursor position marking functions of the operating systems of the computer devices 30[1]-30[n]. Descriptions would be made by taking the computer device 30[1] with Windows operating system as an example, the switching device 20 executes the setting program to generate a second enable signal (not shown), which is related to an operation of the keyboard 11 and/or the mouse 12 (for example, opening Command Prompt in Windows and entering related commands), to the computer device 30[1], so as to enable the first cursor position marking function of the first operating system of the computer device 30[1]. That is to say, the computer device 30[1] automatically enable the first cursor position marking function of the first operating system in response to an operation that the switching device 20 generates the second enable signal. The arrangements of other computer devices 30[2]-30[n] can be deduced by analogy, and therefore the descriptions thereof are omitted herein. It can be appreciated that the second enable signal transmitted by the switching device 20 may be different for different operating system.

Furthermore, when the switching device 20 enters the first setting mode, the user can operate the switching device 20 to switch the keyboard 11 and the mouse 12 from operating the computer device 30[1] to operating one of other computer devices 30[2]-30[n]. After switching, the switching device 20 would automatically execute the setting program to set the computer device which is currently operated by the keyboard 11 and the mouse 12 (i.e., to enable the cursor position marking function of the operating system). After the computer devices 30[1]-30[n] are all set, the switching device 20 can leave the first setting mode automatically or by the control of user.

In some embodiments, the user can control the switching device 20 to enter a second setting mode through an external device (e.g., a mobile device) or by pressing a button (not shown) arranged on the switching device 20. In the second setting mode, the switching device 20 can still transmit the input signal Sin generated by the keyboard 11 and/or the mouse 12 to one of the computer devices 30[1]-30[n]. In addition, only when the switching device 20 enters the second setting mode, the computer devices 30[1]-30[n] can access an application program (not shown) prestored in the memory 206. Descriptions would be made by taking the computer device 30[1] as an example, the user operates the keyboard 11 and/or the mouse 12, so that the computer device 30[1] executes the application program in the memory 206. The computer device 30[1] automatically enables the first cursor position marking function of the first operating system in response to the execution of the application program in the memory 206. In particular, the computer device 30[1] can automatically enable the first cursor position marking function by executing an application program interface (e.g., SystemParametersInfo) or a batch file provided by the first operating system. The arrangements of other computer devices 30[2]-30[n] can be deduced by analogy, and therefore the descriptions thereof are omitted herein. After finishing setting all the computer devices 30[1]-30[n], the switching device 20 can leave the second setting mode automatically or by the control of user.

In the embodiment of FIG. 3B, the descriptions of steps S402-S403 are same or similar to those of steps S301-S302 in FIG. 3A, and therefore are omitted herein.

Method or steps mentioned in present embodiments can be adjusted in order according to practical requirements unless the order thereof is specifically stated, can even be all or partly executed simultaneously, or can be added with related steps. The embodiments of FIGS. 3A and 3B are only examples and are not intended to limit the present disclosure. For example, in some embodiments, before executing step S301 or S401, the switching device 20 can receive information related to the operating systems of the computer devices 30[1]-30[n], so that the processor 200 of the switching device 20 is aware of the operating system of each of the computer devices 30[1]-30[n]. For example, the switching device 20 can receive related information by connecting with an external device (e.g., a mobile device of the user).

Referring to FIG. 4A, FIG. 4A is a schematic diagram of the cursor position marking effect which is displayed on the display device 40[2] in response to the trigger operation of the input device in accordance with some embodiments of the present disclosure. Referring to FIGS. 2 and 4A together, in the embodiment of FIG. 4A corresponding to aforementioned step S302 or S403, the mouse 12 is rapidly moved in a small area (i.e., the first predetermined movement operation) by the user to generate the corresponding input signal Sin to the switching device 20. The switching device 20 processes the input signal Sin generated by the mouse 12 to obtain a movement track T of the cursor 50. The switching device 20 further determines that the input signal Sin generated by the mouse 12 is related to the first predetermined movement operation (i.e., the switching device 20 detects the trigger operation) according to the movement track T of the cursor 50, and thereby driving the second operating system of the computer device 40[2] currently operated by the mouse 12 to execute the second cursor position marking function, so as to display the cursor position marking effect on the display device 40[2] electrically coupled to the computer device 30[2]. In some embodiments, the second operating system of the computer device 40[2] is Mac operating system, and the cursor position marking effect displayed by the display device 40[2] is an amplified cursor 60, which is based on the original function of Mac operating system.

Referring to FIG. 4B, FIG. 4B is a schematic diagram of the cursor position marking effect which is displayed on the display device 40[2] in response to the trigger operation of the input device in accordance with some embodiments of the present disclosure. Referring to FIGS. 2 and 4B together, in the embodiment of FIG. 4B corresponding to aforementioned step S302 or S403, the mouse 12 is moved by the user to switch from operating the computer device 30[1] to operating the computer device 30[2] (i.e., the first predetermined movement operation) and to generate the corresponding input signal Sin to the switching device 20. The switching device 20 processes the input signal Sin generated by the mouse 12 to obtain a displacement (e.g., a linear distance between a position A and a position B in FIG. 4B) of the cursor 50. The switching device 20 further determines that the input signal Sin generated by the mouse 12 is related to the first predetermined movement operation (i.e., the switching device 20 detects the trigger operation) according to the displacement of the cursor 50. Accordingly, the switching device 20 drives the second operating system of the computer device 40[2] currently operated by the mouse 12 to execute the second cursor position marking function, so as to display the cursor position marking effect (which is also the amplified cursor 60) on the display device 40[2] electrically coupled to the computer device 30[2].

In some embodiments, as the embodiment of FIG. 1, the switching device 20 not only detects the trigger operation of the input device 10, but also detects whether the input device 10 temporarily stops for a predetermined period (e.g., 3 second) after the trigger operation. When the switching device 20 detects the trigger operation of the input device 10 and further detects that the input device 10 temporarily stops for the predetermined period after the trigger operation, the switching device 20 drives one of the computer devices 30[1]-30[n]. The aforementioned embodiment would be described in detail below with reference to FIG. 4C.

Referring to FIG. 4C, FIG. 4C is a schematic diagram of the cursor position marking effect which is displayed on the display device 40[1] in response to the trigger operation and the temporary stop of the input device in accordance with some embodiments of the present disclosure. Referring to FIGS. 2 and 4C together, in the embodiment of FIG. 4C, the mouse 12 is moved by the user to perform two switching operations (that is, first switching from operating the computer device 30[1] to operating the computer device 30[2], and then switching from operating the computer device 30[2] to operating the computer device 30[1]).

During a first switching operation, the switching device 20 detects the first predetermined movement operation of the mouse 12 according to a first displacement of the cursor 50 (e.g., a linear distance between a position C and a position D in FIG. 4C) but does not detect that the mouse 12 temporarily stops for the predetermined period after the first predetermined movement operation (because the cursor 50 is moved towards a position E immediately), thereby not driving the computer device 30[2].

During a second switching operation, the switching device 20 not only detects the first predetermined movement operation of the mouse 12 according to a second displacement of the cursor 50 (e.g., a linear distance between the position D and the position E in FIG. 4C) but also detects that the mouse 12 temporarily stops for the predetermined period after the first predetermined movement operation (because the cursor 50 temporarily stops at the position E), thereby driving the first operating system of the computer device 30[1] to execute the first cursor position marking function, so as to display the cursor position marking effect on the display device 40[1] electrically coupled to the computer device 30[1]. In some embodiments, the first operating system of the computer device 30[1] is Windows operating system, and the cursor position marking effect displayed by the display device 40[1] is a ripple 70 which shrinks gradually (represented by one-dot chain lines in FIG. 4C), which is based on the original function of Windows operating system.

According to the aforementioned embodiments, by detecting whether the input device temporarily stops for the predetermined period after the trigger operation, when the input device performs multiple switching operations, it can be avoided that the switching device 20 is triggered multiple times to drive one of the computer devices 30[1]-30[n] to display the cursor position marking effect multiple times on one of the display devices 40[1]-40[n].

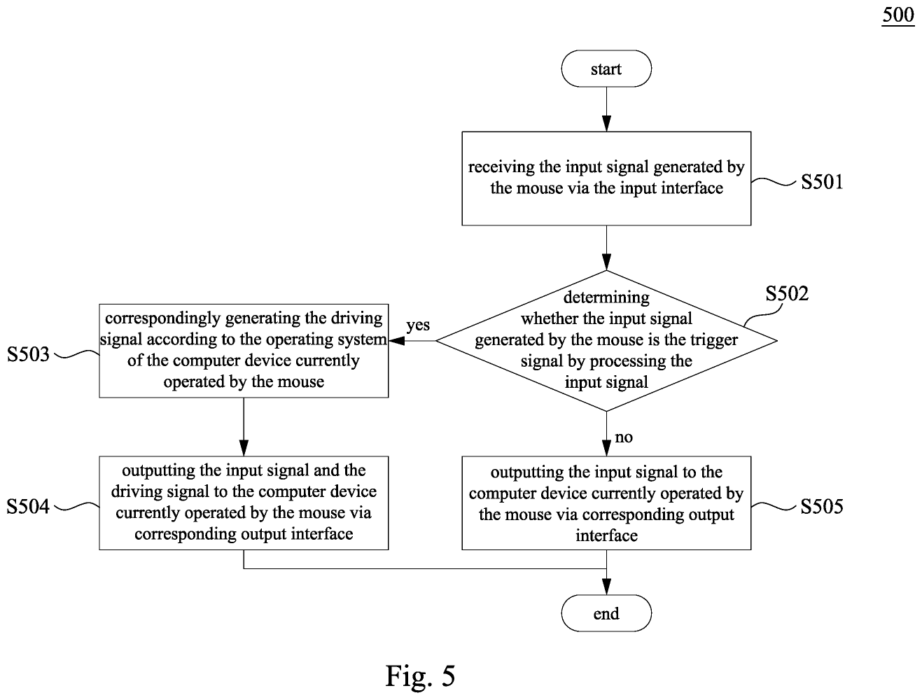

Referring to FIG. 5, FIG. 5 is a flow diagram of an operating method 500 of switching device in accordance with some embodiments of the present disclosure. The operating method 500 can be executed by the switching device 20 of FIG. 1 or 2, but the present disclosure is not limited herein. The operating method 500 includes steps S501-S505. For convenience of description, the operating method 500 would be described below with reference to FIGS. 1-2 and 4A-4C.

In step S501, the switching device 20 receives the input signal Sin generated by the mouse 12 through the input interface 202[2].

In step S502, the switching device 20 determines whether the input signal Sin generated by the mouse 12 is the trigger signal by processing the input signal Sin. For example, the switching device 20 processes the input signal Sin to obtain the movement track (e.g., “T” in FIG. 4A) or the displacement (e.g., the linear distance between the position A and the position B in FIG. 4B) of the cursor 50. The switching device 20 then determines whether the input signal Sin is related to the first predetermined movement operation of the mouse 12 (i.e., a rapid movement in the small area or the switching operation of the mouse 12) according to the movement track or the displacement of the cursor 50, so as to determine whether the input signal Sin is the trigger signal.

In some embodiments, the switching device 20 determines that the input signal Sin is the trigger signal in step S502 to execute step S503. In step S503, the switching device 20 correspondingly generates the driving signal Sd according to the operating system of the computer device which is currently operated by the mouse 12 (i.e., one of the computer devices 30[1]-30[n]). The descriptions of generating the driving signal Sd according to the operating system are same or similar to those of above embodiments, and therefore are omitted herein.

In step S504, the switching device 20 outputs the input signal Sin and the driving signal Sd to the computer device currently operated by the mouse 12 through corresponding output interface (i.e., one of the output interfaces 204[1]-204[n]), to operate the computer device currently operated by the mouse 12 and to display the cursor position marking effect (e.g., the amplified cursor 60, the ripple 70 which shrinks gradually) on corresponding display device (i.e., one of the display devices 40[1]-40[n]).

In some embodiments, the switching device 20 determines that the input signal Sin is not the trigger signal to execute step S505. In step S505, the switching device 20 does not generate the driving signal Sd and outputs the input signal Sin to the computer device currently operated by the mouse 12 through corresponding output interface to operate the computer device currently operated by the mouse 12.

In sum, the computer system 100 of the present disclosure processes the input signal generated by the input device through the switching device 20 to analyze whether the user desires to know the display position of the cursor 50 on the display devices 40[1]-40[n]. When determining that the user desires to know the display position of the cursor 50, the switching device 20 simulates the driving signal Sd, which can drive the operating system to execute the original cursor position marking function, according to the operating system of the computer device currently operated by the input device, to inform the user the display position of the cursor 50 by the cursor position marking effect. In such way, the computer system 100 of the present disclosure can inform the user the display position of the cursor 50 without the external software or hardware, so as to reduce cost and to avoid incompatible problem.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A cursor marking method, comprising:
detecting an operation of at least one input device to at least one computer device via a switching device, wherein the at least one input device is configured to perform at least one trigger operation, to trigger at least one operating system of the at least one computer device to execute a cursor position marking function; and
when the switching device detects the at least one trigger operation, the switching device driving the at least one operating system of the at least one computer device to execute the cursor position marking function, to display a cursor position marking effect on at least one display device electrically coupled to the at least one computer device.

2. The cursor marking method of claim 1, wherein the at least one trigger operation comprises the at least one input device being switched from operating a first computer device of the at least one computer device to operating a second computer device of the at least one computer device, so that the switching device drives a corresponding operating system of the second computer device to execute the cursor position marking function.

3. The cursor marking method of claim 1, wherein the at least one computer device comprises a first computer device and a second computer device, and the step of the switching device driving the at least one operating system of the at least one computer device to execute the cursor position marking function comprises:
when the at least one input device operates the first computer device, the switching device driving a first operating system of the first computer device to execute the cursor position marking function in response to the at least one trigger operation of the at least one input device; and
when the at least one input device operates the second computer device, the switching device driving a second operating system of the second computer device to execute the cursor position marking function in response to the at least one trigger operation of the at least one input device, wherein the first operating system is different from the second operating system.

4. The cursor marking method of claim 3, wherein the at least one input device comprises a keyboard and a mouse,
wherein the step of the switching device driving the first operating system to execute the cursor position marking function comprises:
the switching device generating a first driving signal related to an operation of at least one predetermined key of the keyboard being pressed in response to a first predetermined movement operation of the mouse, to drive the first operating system to execute the cursor position marking function;
wherein the step of the switching device driving the second operating system to execute the cursor position marking function comprises:
the switching device generating a second driving signal related to a second predetermined movement operation of the mouse in response to the first predetermined movement operation of the mouse, to drive the second operating system to execute the cursor position marking function.

5. The cursor marking method of claim 1, further comprising:
the switching device transmitting an enable signal generated by the at least one input device in response to a user operation, to enable the cursor position marking function of the at least one operating system.

6. The cursor marking method of claim 1, further comprising:
the at least one computer device automatically enabling the cursor position marking function of the at least one operating system in response to an operation of the switching device.

7. The cursor marking method of claim 1, further comprising:
the at least one computer device enabling the cursor position marking function of the at least one operating system in response to an execution of an application program prestored in the switching device.

8. A switching device, comprising:
at least one input interface configured to electrically couple to at least one input device;
a plurality of output interfaces configured to electrically couple to a plurality of computer devices; and
a processor electrically coupled to the at least one input interface and the plurality of output interfaces, configured to receive at least one input signal generated by the at least one input device via the at least one input interface, and configured to output the at least one input signal via one of the plurality of output interfaces to operate one of the plurality of computer devices;
wherein the processor is further configured to generate at least one driving signal in response to at least one trigger signal generated by the at least one input device performing a trigger operation, to drive a corresponding operating system of one of the plurality of computer devices to execute a cursor position marking function via a corresponding output interface of the plurality of output interfaces.

9. The switching device of claim 8, wherein the plurality of computer devices comprises a first computer device and a second computer device, the trigger operation comprises the at least one input device being switched from operating the second computer device to operating the first computer device, so that the processor is configured to generate a first driving signal and drive a first operating system of the first computer device to execute the cursor position marking function via a first output interface of the plurality of output interfaces, to display a cursor position marking effect on a first display device electrically coupled to the first computer device.

10. The switching device of claim 9, wherein when the at least one input device operates the second computer device, the processor is configured to generate a second driving signal and drive a second operating system of the second computer device to execute the cursor position marking function via a second output interface of the plurality of output interfaces, to display the cursor position marking effect on a second display device electrically coupled to the second computer device;
wherein the first operating system is different from the second operating system, and the first driving signal is different from the second driving signal.

11. The switching device of claim 8, wherein the at least one input device comprises a keyboard and a mouse, the processor is further configured to generate the at least one driving signal related to an operation of at least one predetermined key of the keyboard being pressed, a second predetermined movement operation of the mouse or a combination thereof in response to a first predetermined movement operation of the mouse, to drive a corresponding operating system of one of the plurality of computer devices to execute the cursor position marking function via a corresponding output interface of the plurality of output interfaces.

12. The switching device of claim 8, wherein the processor is further configured to receive an enable signal generated by the at least one input device being operated and transmit the enable signal to a corresponding computer device of the plurality of computer devices, to enable the cursor position marking function of a corresponding operating system of the corresponding computer device.

13. The switching device of claim 8, wherein the processor is further configured to execute a setting program when being not in response to an operation of the at least one input device, to enable the cursor position marking function of a corresponding operating system of one of the plurality of computer devices.

14. The switching device of claim 8, further comprising:
a memory electrically coupled to the processor and configured to store an application program;
wherein a corresponding computer device of the plurality of computer devices is configured to access the application program through the processor, to enable the cursor position marking function of a corresponding operating system of the corresponding computer device.

15. A computer system, comprising:
a plurality of display devices;
a plurality of computer devices electrically coupled to the plurality of display devices respectively;
at least one input device configured to perform at least one trigger operation to generate at least one trigger signal; and
a switching device electrically coupled to the at least one input device, and driving a corresponding operating system of one of the plurality of computer devices to execute a cursor position marking function in response to the at least one trigger signal generated by the at least one input device, to display a cursor position marking effect on a corresponding display device electrically coupled to one of the plurality of computer devices.

16. The computer system of claim 15, wherein the at least one trigger operation comprises the at least one input device being switched from operating a first computer device of the plurality of computer devices to operating a second computer device of the plurality of computer devices, and when the at least one input device is switched to operate the second computer device, the switching device generates at least one driving signal to the second computer device, to drive a corresponding operating system of the second computer device to execute the cursor position marking function.

17. The computer system of claim 15, wherein the at least one input device comprises a keyboard and a mouse, the at least one trigger operation comprises a first predetermined movement operation of the mouse, and the switching device is configured to generate at least one driving signal related to an operation of at least one predetermined key of the keyboard being pressed, a second predetermined movement operation of the mouse or a combination thereof to one of the plurality of computer devices in response to the first predetermined movement operation of the mouse, to drive the corresponding operating system of one of the plurality of computer devices to execute the cursor position marking function.

18. The computer system of claim 15, wherein one of the plurality of computer devices enables the cursor position marking function of the corresponding operating system of one of the plurality of computer devices in response to an operation of the switching device.

19. The computer system of claim 15, wherein the switching device stores an application program, and one of the plurality of computer devices accesses the application program through the switching device, to enable the cursor position marking function of the corresponding operating system of one of the plurality of computer devices.
